(19) United States
(12) Patent Application Publication
(10) Pub. No.: US 2023/0222380 A1
(43) Pub. Date: Jul. 13, 2023

(54) ONLINE CONTINUAL LEARNING METHOD AND SYSTEM

(71) Applicant: MACRONIX INTERNATIONAL CO., LTD., Hsinchu (TW)

(72) Inventors: Sheng-Feng YU, Hsinchu City (TW); Wei-Chen CHIU, Tainan City (TW)

(21) Appl. No.: 17/749,194

(22) Filed: May 20, 2022

Related U.S. Application Data
(60) Provisional application No. 63/298,986, filed on Jan. 12, 2022.

(51) Int. Cl. G06N 20/00

(52) U.S. Cl. CPC G06N 20/00

(57) ABSTRACT

An online continual learning method and system are provided. The online continual learning method includes: receiving a plurality of training data of a class under recognition; applying a discrete and deterministic augmentation operation on the plurality of training data of the class under recognition to generate a plurality of intermediate classes; generating a plurality of view data from the intermediate classes; extracting a plurality of characteristic vectors from the view data; and training a model based on the feature vectors.

This application claims the benefit of U.S. Provisional Application Serial No. 63/298,986, filed Jan. 12, 2022, the subject matter of which is incorporated herein by reference.

### TECHNICAL FIELD

The disclosure relates in general to an online continual learning method and system.

### BACKGROUND

Continual Learning is a concept to learn a model for a large number of tasks sequentially without forgetting knowledge obtained from the preceding tasks, where only a small part of the old task data are stored.

Online continual learning systems deal with new concept (for example but not limited by, class, domain, environment (for example, playing new online game)) and maintains the model performance. At now, the online continual learning systems face the issue of catastrophic forgetting and imbalanced learning.

Catastrophic forgetting refers to that, the online continual learning systems forget old concepts during learning new concepts. Imbalanced learning refers to that the size of examples of old concepts is smaller than the dataset of the new concept, and thus the classification result tends to the new concept.

Thus, there needs an online continual learning method and system, which address issues of the conventional online continual learning method and system.

### SUMMARY

According to one embodiment, an online continual learning method is provided. The online continual learning method includes: receiving a plurality of training data of a class under recognition; applying a discrete and deterministic augmentation operation on the plurality of training data of the class under recognition to generate a plurality of intermediate classes; generating a plurality of view data from the intermediate classes; extracting a plurality of characteristic vectors from the view data; and training a model based on the feature vectors.

According to another embodiment, an online continual learning system is provided. The online continual learning system includes: a semantically distinct augmentation (SDA) module for receiving a plurality of training data of a class under recognition and applying a discrete and deterministic augmentation operation on the plurality of training data of the class under recognition to generate a plurality of intermediate classes; a view data generation module coupled to the semantically distinct augmentation module, for generating a plurality of view data from the intermediate classes; a feature extracting module coupled to the view data generation module, for extracting a plurality of characteristic vectors from the view data; and a training function module coupled to the feature extracting module, for training a model based on the feature vectors.

### BRIEF DESCRIPTION OF THE DRAWINGS

FIG. 1 shows a flow chart for an online continual learning method according to a first embodiment of the application.

FIG. 2A and FIG. 2B show operations of the first embodiment of the application.

FIG. 3 shows the permutation operation according to one embodiment of the application.

FIG. 4 shows a flow chart for an online continual learning method according to a second embodiment of the application.

FIG. 5A and FIG. 5B show operation diagrams.

FIG. 6 shows operations of the fully-connected layer classifier model in the second embodiment of the application.

FIG. 7 shows a flow chart for an online continual learning method according to a third embodiment of the application.

FIG. 8 shows a functional block of an online continual learning system according to one embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

### First Embodiment

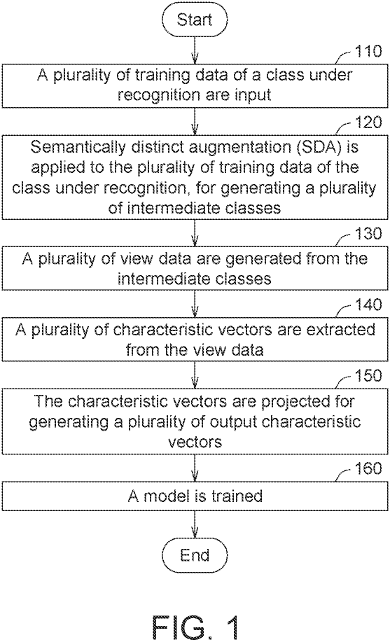

FIG. 1 shows a flow chart for an online continual learning method according to a first embodiment of the application. In step 110, a plurality of training data of a class under recognition are input into an online continual learning system. In step 120, semantically distinct augmentation (SDA) is applied to the plurality of training data of the class under recognition, for generating a plurality of intermediate classes. In step 130, a plurality of view data are generated from the intermediate classes. In step 140, a plurality of characteristic vectors are extracted from the view data. In step 150, the characteristic vectors are projected into another low dimension space (for example but not limited by, a two-layers Perceptron) for generating a plurality of output characteristic vectors. In step 160, a model is trained, wherein the output characteristic vectors from the same intermediate class are attracted to each other, while the output characteristic vectors from the different intermediate class are repelled from each other. Step 160 is for example but not limited by, contrastive learning (CL).

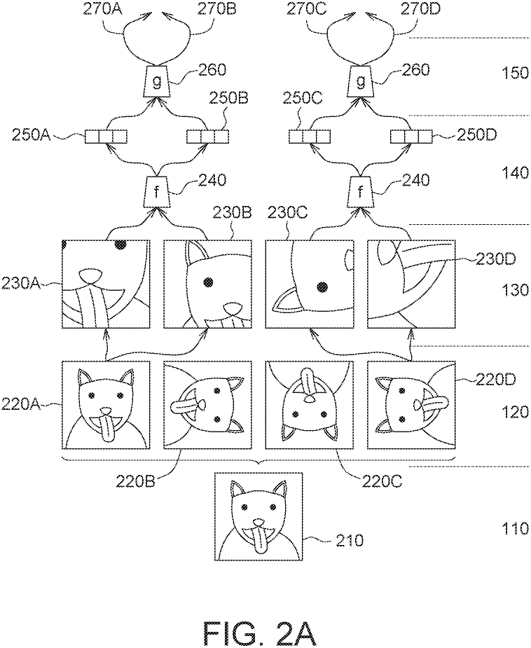

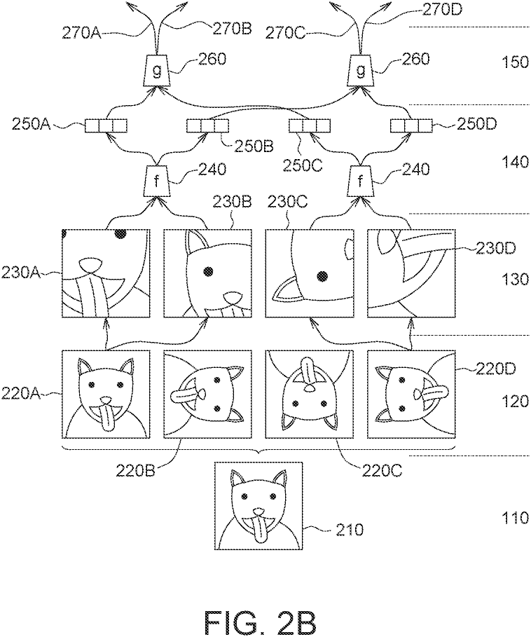

FIG. 2A and FIG. 2B show operations of the first embodiment of the application. Referring to FIG. 1, FIG. 2A and FIG. 2B. SDA is applied to the plurality of training data 210 of the class under recognition, for generating a plurality of intermediate classes 220A∼220D.

In one embodiment of the application, the SDA operations are discrete and deterministic. The SDA operations include for example but not limited by, rotation or permutation.

The rotation operation refers to that, the training data 210 of the class under recognition are rotated for generating the intermediate classes 220A∼220D. As shown in FIG. 2A and FIG. 2B, the training data 210 of the class under recognition is rotated zero degree for generating the intermediate class 220A; the training data 210 of the class under recognition is rotated 90 degrees for generating the intermediate class 220B; the training data 210 of the class under recognition is rotated 180 degrees for generating the intermediate class 220C; and the training data 210 of the class under recognition is rotated 270 degrees for generating the intermediate class 220D. The rotation degree is discrete and deterministic.

For example but not limited by, there are two original classes: cat and dog. The SDA operations generate eight intermediate classes: cat 0, cat 90, cat 180, cat 270, dog 0, dog 90, dog 180 and dog 270. Wherein, cat 0, cat 90, cat 180, cat 270 refer that the intermediate classes generated from rotating cat by 0 degree, 90 degrees, 180 degrees and 270 degrees. That is to say, the number of the intermediate classes are K times of the number of the original classes (in the above example K=4 which is not limit the application, K referring the size of SDA).

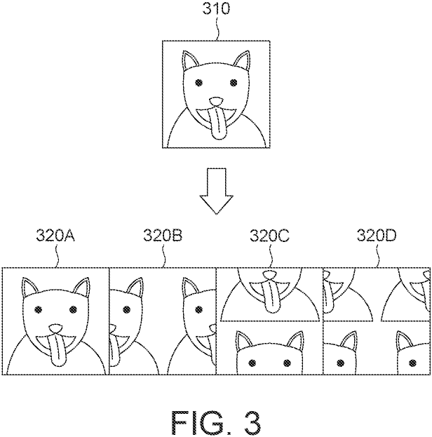

The permutation operation refers to that, the training data 210 of the class under recognition are permuted for generating the intermediate classes. FIG. 3 shows the permutation operation according to one embodiment of the application. As shown in FIG. 3, the training data 310 of the class under recognition is no-permuted for generating the intermediate class 320A; the training data 310 of the class under recognition is left-right-permuted (that is, the left half and the right half are switched or permuted) for generating the intermediate class 320B; the training data 310 of the class under recognition is top-bottom-permuted (that is, the top half and the bottom half are switched or permuted) for generating the intermediate class 320C; the training data 310 of the class under recognition is top-bottom-left-right-permuted (that is, the top half and the bottom half are switched or permuted and then the left half and the right half are switched or permuted) for generating the intermediate class 320D. The permutation is discrete and deterministic.

Refer to FIG. 2A and FIG. 2B for details of generating the view data in step 130. In one embodiment of the application, the intermediate classes (the intermediate classes 220A and 220B in FIG. 2A and FIG. 2B) are randomly cropped and the image cropped from the intermediate classes are performed by color distortion. For example but not limited by, the intermediate class 220A is randomly cropped and the image cropped from the intermediate classes are performed by color distortion (for example but not limited by, painted by yellow color) into the view data 230A; the intermediate class 220A is randomly cropped and the image cropped from the intermediate classes are performed by color distortion (for example but not limited by, painted by red color) into the view data 230B; the intermediate class 220D is randomly cropped and the image cropped from the intermediate classes are performed by color distortion (for example but not limited by, painted by green color) into the view data 230C; and the intermediate class 220D is randomly cropped and the image cropped from the intermediate classes are performed by color distortion (for example but not limited by, painted by purple color) into the view data 230D.

A feature extractor 240 performs feature extraction on the view data 230A-230D to generate a plurality of feature vectors 250A~250D. For example but not limited by, one feature vector is generated from one view data, i.e. the feature vector and the view data are one-to-one relationship.

The plurality of feature vectors 250A∼250D are projected to a lower dimension space by a Multilayer Perceptron (MLP) 260 to generate a plurality of output feature vectors 270A∼270D.

A model is trained by contrastive learning, so that the output feature vectors generated from the same intermediate class attract each other and the output feature vectors generated from the different intermediate classes repel from each other. As shown in FIG. 2A and FIG. 2B, when the output feature vectors 270A and 270B are generated from the same intermediate class (220A∼220D), the output feature vectors 270A and 270B attract each other. On the contrary, when the output feature vectors 270A and 270B are generated from the different intermediate classes (220A∼220D), the output feature vectors 270A and 270B repel from each other.

In the first embodiment of the application, SDA encourages the trained model to learn diverse features within a single phase. Therefore, SDA is stable and suffers less catastrophic forgetting.

In the first embodiment of the application, data of the class under recognition is performed by discrete and deterministic augmentation (for example but not limited by, rotation, permutation). If two augmented images have the same original class and the same augmented class, then they are classified as the same intermediate class; and vice versa. Thus, by adjusting the model parameters, the images (the feature vectors) from the different intermediate classes repel from each other while the images (the feature vectors) from the same intermediate class attract each other.

Further, in the first embodiment of the application, the transformation augmentation (for example, rotation, and permutation) has different semantic meaning. The transformation augmentation (for example, rotation, and permutation) may be used to generate a lot of intermediate classes. Thus, learning on the intermediate classes helps the model to generate a diverse feature vectors. It helps to separate the trained classes from future unseen classes.

### Second Embodiment

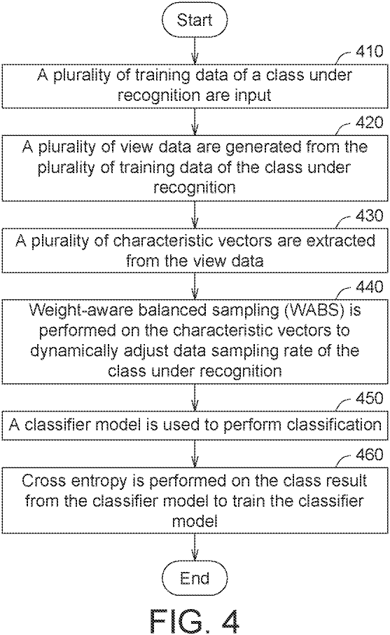

FIG. 4 shows a flow chart for an online continual learning method according to a second embodiment of the application. In step 410, a plurality of training data of a class under recognition are input into an online continual learning system. In step 420, a plurality of view data are generated from the plurality of training data of the class under recognition. The step 420 is optional which depends on user requirements. In step 430, a plurality of characteristic vectors are extracted from the view data. In step 440, weight-aware balanced sampling (WABS) is performed on the characteristic vectors to dynamically adjust data sampling rate of the class under recognition. In step 450, a classifier model (C) is used to perform classification. In step 460, cross entropy (CE) is performed on the class result from the classifier model to train the classifier model.

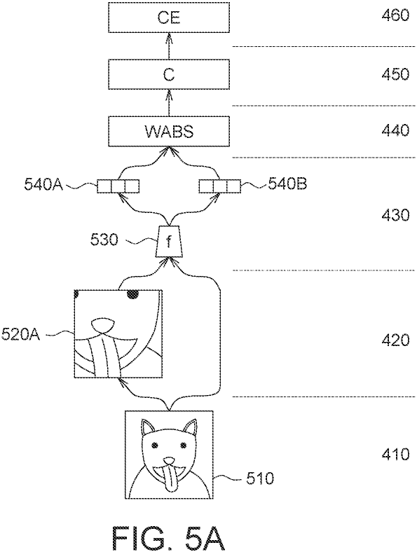

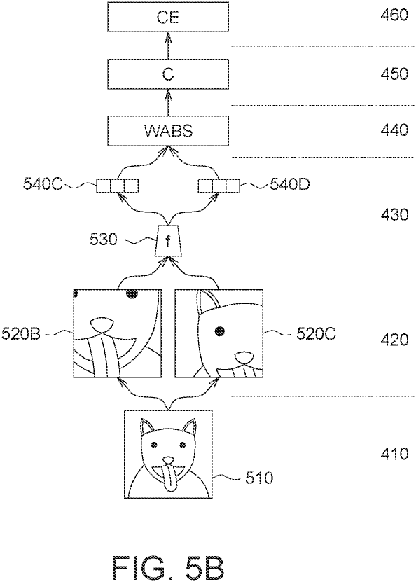

FIG. 5A and FIG. 5B show operation diagrams. FIG. 5A shows supervised contrastive replay (SCR) while FIG. 5B shows supervised contrastive learning (SCL), which are not to limit the application. In FIG. 5A and FIG. 5B, the step 420 of generating the view data is optional which depends on user requirements.

Refer to FIG. 4, FIG. 5A and FIG. 5B. A plurality of view data 520A∼520C are generated by a training data 510 of the class under recognition. In the second embodiment, generation of the view data may be the same or similar to that in the first embodiment, and thus the details are omitted here.

A feature extractor 530 extracts a plurality of feature vectors 540A∼540D from the view data 520A∼520C.

WABS operations are performed on the plurality of feature vectors 540A~540D to dynamically adjust the data sampling rate of the class under recognition.

For example but not limited by, the data sampling rate rₜ of the training data of the class under recognition is expressed as the formula (1):

$${\text{r}}_{\text{t}} \text{=min} \left(1 , \frac{2 ∗ \text{exp} \left(\text{wold} / \text{tw}\right)}{\text{exp} \left(\frac{\text{wold}}{\text{tw}}\right) + \text{exp} \left(\frac{\text{wt}}{\text{tw}}\right)}\right)$$

In the formula (1), “tw” refers to a self-defined hyperparameter. Other parameters “wold” and “wt” are described as follows.

By dynamically adjusting the data sampling rate rₜ of the training data of the class under recognition, the classifier is balanced and thus the imbalanced issue is prevented.

In the second embodiment of the application, the classifier model used in the step 450 is for example but not limited by, a fully-connected layer classifier model.

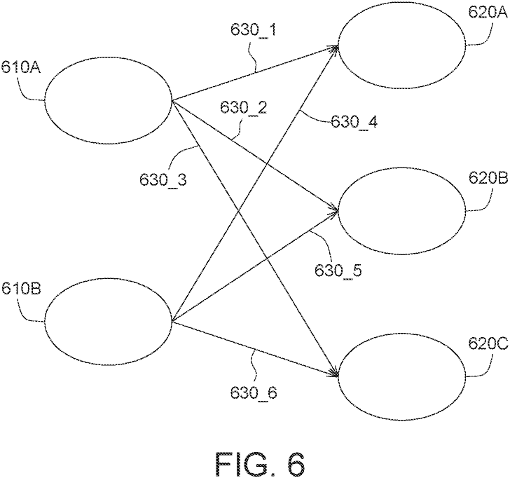

FIG. 6 shows operations of the fully-connected layer classifier model in the second embodiment of the application. The fully-connected layer classifier model connects the feature vectors 610A~610B to the classes 620A~620C, wherein each of the feature vectors 610A~610B is connected all classes 620A∼620C. The classes 620A∼620B are the learned old classes and the class 620C is the unlearned class under recognition. As shown in FIG. 6, there are six weights 630_1~630_6 connected between the feature vectors 610A~610B and the classes 620A∼620C. The weights 630_1, 630_2, 630_4 and 630_5 are connected between the feature vectors 610A~610B and the old classes 620A∼620B, and thus an old class weight average wold is generating by averaging the weights 630_1, 630_2, 630_4 and 630_5. The weights 630_3 and 630_6 are connected between the feature vectors 610A~610B and the class 620C under recognition. A class-under-recognition weight average wt is generating by averaging the weights 630_3 and 630_6.

When the class-under-recognition weight average wt is too high, which means the classifier model C tends to the class 620C under recognition. The value of the weight is corresponding to the number of the training data. Basically, the respective number of data in each class is unknown. However, in the second embodiment of the application, the respective values of the weights 630_1~630_6 are known. Thus, the respective number of data in each class may be estimated based on the values of the weights.

Thus, when the class-under-recognition weight average wt is too high, the data sampling rate of the class under recognition is adjusted to be smaller by the formula (1).

In the second embodiment of the application, by introducing the fully-connected layer classifier model, the training efficiency is improved, and recency bias is prevented by applying WABS before the classifier model.

Further, in the second embodiment of the application, the fully-connected layer classifier model and cross entropy may use the class related information (for example but not limited by, the weight average) to train the model. Therefore, in the second embodiment of the application, it requires fewer training iterations to get convergence. Therefore, in the second embodiment of the application, the fully-connected layer classifier model to additionally train the feature vectors for quickly achieving the convergence in limited training iterations.

Still further, in the second embodiment of the application, by dynamically adjusting data sampling rate of the training data, imbalanced learning issue is addressed.

In the second embodiment of the application, the fully-connected layer classifier model may speed up the training speed.

### Third Embodiment

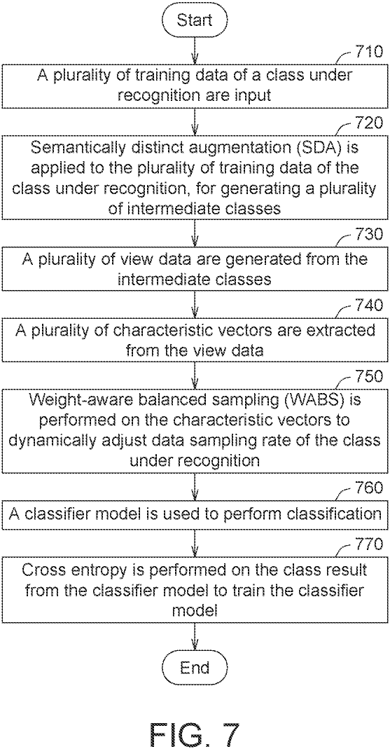

FIG. 7 shows a flow chart for an online continual learning method according to a third embodiment of the application. The third embodiment is a combination of the first embodiment and the second embodiment. In step 710, a plurality of training data of a class under recognition are input into an online continual learning system. In step 720, semantically distinct augmentation (SDA) is applied to the plurality of training data of the class under recognition, for generating a plurality of intermediate classes. In step 730, a plurality of view data are generated from the intermediate classes. In step 740, a plurality of characteristic vectors are extracted from the view data. In step 750, weight-aware balanced sampling (WABS) is performed on the characteristic vectors to dynamically adjust data sampling rate of the class under recognition. In step 760, a classifier model is used to perform classification. In step 770, cross entropy is performed on the class result from the classifier model to train the classifier model.

Details of the steps 710-770 may be the same as those in the first embodiment or the second embodiment, and thus are omitted here.

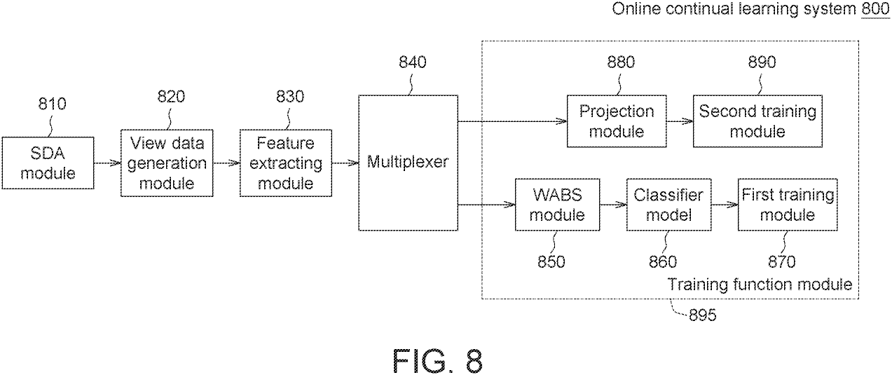

FIG. 8 shows a functional block of an online continual learning system according to one embodiment of the application. As shown in FIG. 8, the online continual learning system 800 according to one embodiment of the application includes an SDA module 810, a view data generation module 820, a feature extracting module 830, a multiplexer 840, a WABS module 850, a classifier model 860, a first training module 870, a projection module 880 and a second training module 890. The WABS module 850, the classifier model 860, the first training module 870, the projection module 880 and the second training module 890 may be collectively referred as a training function module 895.

The multiplexer 840 may select to input the feature vectors from the feature extracting module 830 into either the WABS module 850 or the projection module 880 or both based on user selection.

The semantically distinct augmentation module 810 receives a plurality of training data of a class under recognition and applies semantically distinct augmentation operations on the plurality of training data of the class under recognition to generate a plurality of intermediate classes. The semantically distinct augmentation module 810 performs rotation or permutation on the plurality of training data of the class under recognition to generate the plurality of intermediate classes.

The view data generation module 820 is coupled to the semantically distinct augmentation module 810, for generating a plurality of view data from the intermediate classes.

The feature extracting module 830 is coupled to the view data generation module 820, for extracting a plurality of characteristic vectors from the view data.

The training function module 895 is coupled to the feature extracting module 830 via the multiplexer 840, for training a model based on the feature vectors.

The WABS module 850 is coupled to the feature extracting module 830 via the multiplexer 840, for performing weight-aware balanced sampling on the characteristic vectors to dynamically adjust a data sampling rate of the class under recognition.

The classifier model 860 is coupled to the WABS module 850, for performing classification by the model.

The first training module 870 is coupled to the classifier model 860, for performing cross entropy on a class result from the model to train the model.

The projection module 880 is coupled to the feature extracting module 830 via the multiplexer 840, for projecting the characteristic vectors into another dimension space to generate a plurality of output characteristic vectors.

The second training module 890 is coupled to the projection module 880. The second training module 890 is for training the model based on the output characteristic vectors. The output characteristic vectors from the same intermediate class are attracted to each other, while the output characteristic vectors from the different intermediate class are repelled from each other.

The SDA module 810, the view data generation module 820, the feature extracting module 830, the multiplexer 840, the WABS module 850, the classifier model 860, the first training module 870, the projection module 880 and the second training module 890 may have details as the above embodiments and thus are omitted here.

In the above embodiments, the definition of “class” may include “domains or environments”. For example but not limited by, in learning synthetic data and real data, synthetic data and real data belong to different domains or different environments. Other possible embodiments of the application may learn synthetic data in synthetic domains, and then learn real data in real domains. That is, synthetic domains are the known (learned) class while real domains are the unknown (unlearned) class.

The conventional online continual learning systems may face catastrophic forgetting. The SDA in the above embodiments of the application may generate images (or intermediate classes) having different semantic meaning. Via images (or intermediate classes) from SDA learning, the classifier model have better performance and less forgetting.

The conventional online continual learning systems may face recency bias. The WABS in the embodiments of the application may address the recency bias and improve train efficiency.

AI (artificial intelligence) model on client devices may learn new concepts during the service period. The embodiments of the application facilitate the model learning, alleviate the catastrophic forgetting, and resolve the recency bias.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An online continual learning method including:
receiving a plurality of training data of a class under recognition;
applying a discrete and deterministic augmentation operation on the plurality of training data of the class under recognition to generate a plurality of intermediate classes;
generating a plurality of view data from the intermediate classes;
extracting a plurality of characteristic vectors from the view data; and
training a model based on the feature vectors.

2. The online continual learning method according to claim 1, wherein the step of training the model based on the feature vectors includes:
projecting the characteristic vectors to generate a plurality of output characteristic vectors; and
training the model based on the output characteristic vectors, wherein the output characteristic vectors from the same intermediate class are attracted to each other, while the output characteristic vectors from the different intermediate class are repelled from each other.

3. The online continual learning method according to claim 2, wherein the step of projecting the characteristic vectors including:
projecting the characteristic vectors into another dimension space.

4. The online continual learning method according to claim 1, wherein the step of applying the discrete and deterministic augmentation operation on the plurality of training data of the class under recognition includes:
performing either rotation or permutation on the plurality of training data of the class under recognition to generate the plurality of intermediate classes.

5. The online continual learning method according to claim 1, wherein the step of training the model based on the feature vectors includes:
performing weight-aware balanced sampling on the characteristic vectors to dynamically adjust a data sampling rate of the class under recognition;
performing classification by the model; and
performing cross entropy on a class result from the model to train the model.

6. An online continual learning system including:
a semantically distinct augmentation (SDA) module for receiving a plurality of training data of a class under recognition and applying a discrete and deterministic augmentation operation on the plurality of training data of the class under recognition to generate a plurality of intermediate classes;
a view data generation module coupled to the semantically distinct augmentation module, for generating a plurality of view data from the intermediate classes;
a feature extracting module coupled to the view data generation module, for extracting a plurality of characteristic vectors from the view data; and
a training function module coupled to the feature extracting module, for training a model based on the feature vectors.

7. The online continual learning system according to claim 6, wherein the training function module includes:
a projection module coupled to the feature extracting module, for projecting the characteristic vectors to generate a plurality of output characteristic vectors; and
a second training module coupled to the projection module, for training the model based on the output characteristic vectors, wherein the output characteristic vectors from the same intermediate class are attracted to each other, while the output characteristic vectors from the different intermediate class are repelled from each other.

8. The online continual learning system according to claim 7, wherein the projection module projects the characteristic vectors into another dimension space.

9. The online continual learning system according to claim 6, wherein the SDA module performs either rotation or permutation on the plurality of training data of the class under recognition to generate the plurality of intermediate classes.

10. The online continual learning system according to claim 6, wherein the training function module includes:
a weight-aware balanced sampling (WABS) module coupled to the feature extracting module, for performing weight-aware balanced sampling on the characteristic vectors to dynamically adjust a data sampling rate of the class under recognition;
a classifier model coupled to the WABS module, for performing classification by the model; and
a first training module coupled to the classifier model, for performing cross entropy on a class result from the model to train the model.
